(19) United States
(12) Patent Application Publication
(10) Pub. No.: US 2007/0228665 A1
(43) Pub. Date: Oct. 4, 2007

(54) Flat gasket, especially a cylinder head gasket

(75) Inventors: Thomas Schumacher, Riederich (DE); Klaus Bendl, Oberderdingen (DE); Peter Schweizer, Grafenberg (DE)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: ElringKlinger AG

(21) Appl. No.: 11/723,014

(22) Filed: Mar. 15, 2007

(30) Foreign Application Priority Data
Mar. 29, 2006 (DE) 10 2006 014 386.8

(51) Int. Cl. F02F 11/00

(52) U.S. Cl. 277/592

(57) ABSTRACT

In a flat gasket, especially a cylinder head gasket, having at least one elongated, metallic carrier element (17) which extends over several sealing zones, preferably over several combustion chamber sealing zones (41) for several in-line cylinders of a piston engine, the carrier element (17) is formed by several component elements (7, 9, 11) which are interconnected by a connecting means (23, 35), abutting one another (at 13).

The invention relates to a flat gasket, especially a cylinder head gasket, having at least one elongated, metallic carrier element which extends over several sealing zones, preferably over several combustion chamber sealing zones for several in-line cylinders of a piston engine.

In flat gaskets of this type, especially when they are designed as a cylinder head gasket in internal combustion engines, on the carrier element conventionally outside of the combustion chamber sealing zones there are other sealing zones which are sealed by elastomer gasket materials. These sealing zones can be among other things for example openings which are made in the carrier element as a passage for cylinder head bolts, as channels for coolant or lubricant fluids, as passages for mechanical components of the valve control or the like. These openings or passages are conventionally bordered by elastomer sealing lips attached to the carrier element, for example rubber lips. The outer edges of the carrier element can also be provided with a rubber lip.

When used in internal combustion engines with a plurality of in-line cylinders, for example six and more cylinders, as are conventional in commercial vehicles, the carrier element has a correspondingly great overall length. Due to the instability of the thin-walled metallic carrier element which results from the great overall length, problems however arise in the attachment of the sealing lips. In order to ensure a precise fit, the sealing lips are prefabricated as inserts and are attached to the carrier element by a mounting process.

With respect to this prior art, the object of the invention is to make available a flat gasket, especially a cylinder head gasket, in which the execution of the sealing lips is simplified even if it is a seal of great overall length.

As claimed in the invention, this object is achieved by a flat gasket, especially a cylinder head gasket, which has the features of claim 1 in its entirety.

In that, as claimed in the invention, the carrier element is subdivided into several component elements, for the respective component element there is accordingly a length corresponding only to the partial amount of the overall length, it becomes possible to easily make the sealing lips by the elastomer material being injected directly onto the carrier element. The steps of separate manufacture of inserts and their installation are thus eliminated.

Preferably provision is furthermore made such that there is at least one support element extending essentially over the length of the carrier element adjoining the latter and it is formed from several interconnected component elements. This enables especially a multilayer structure for the flat gasket as a cylinder head gasket. The carrier element which is composed of several component elements and which extends with them in one plane forms in this respect preferably the middle layer of one preferred cylinder head gasket which is made with three layers and which is supported by way of support elements which are likewise built up from several parts on their top and bottom as a top and bottom cover layer and accordingly is stiffened. Altogether this yields a stiff gasket combination which has the necessary sealing elasticity for the adjoining cylinder spaces in the engine block especially in the area of the actual sealing sites. In this connection it has proven especially advantageous for the number of component elements of the carrier element to be different from the number of component elements of the support element from one another, the joining sites of the component elements of the carrier element and of the support elements which form the cover layers being spaced axially apart from one another in the longitudinal direction of the flat gasket. Since the joining sites of the different layers are at least axially offset from the cover layer to the middle layer, this yields additional stiffening of the entire multilayer combination. Stresses which are thermally induced can also be easily managed and routed into the structure of the flat gasket. Stress peaks which occur regionally are thus likewise compensated like possible bulging effects in the individual sheet metal layers. Due to the modular configuration the individual sealing layers with their component elements moreover can be modularly assembled depending on the number of cylinder units; this has proven especially economical within the framework of production.

For gaskets in which besides the carrier element on one side or both sides there is a support element which extends essentially over the entire length of the carrier element the configuration can be such that the respective support element is formed from interconnected component elements.

Preferably in this connection there is a second connecting means which is active both between component elements of the two support elements and also component elements of the carrier element.

The first connecting means which is active between the component elements of the carrier element can advantageously be a riveted connection, while the second connecting means can be cramping which is formed by retaining projections which are molded in one piece on one of the support elements as projecting parts and can be deformed for cramping engagement with the other support element. Advantageously in this configuration in a single step the connection can be established by pressing the respective connecting elements of the riveted connection and the cramping.

The riveted connection and the cramping are preferably designed so that narrowly limited relative motion of the respective component elements connected is possible in order to enable compensation of changes in the geometry of the components due to thermal or dynamic loads.

The invention will be detailed below using one embodiment shown in the drawings.

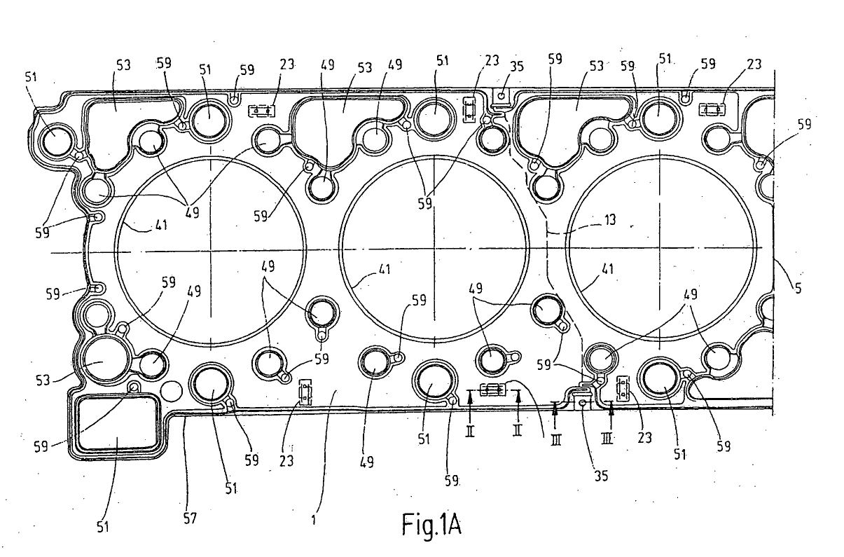

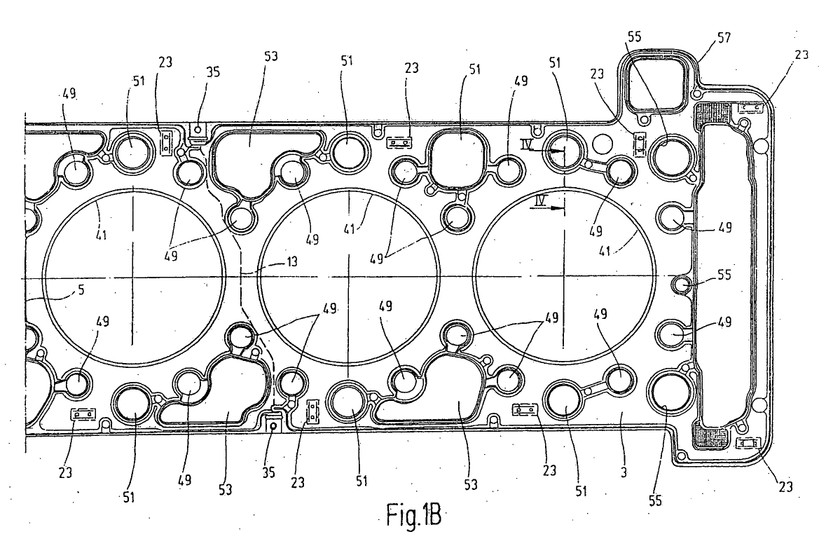

FIGS. 1A and 1B each show in an elevational view one half of an embodiment of the flat gasket as claimed in the invention in the form of a cylinder head gasket for a six-cylinder in-line engine, FIG. 1A showing the gasket half for cylinders one to three and FIG. 1B showing the gasket half for cylinders four to six,

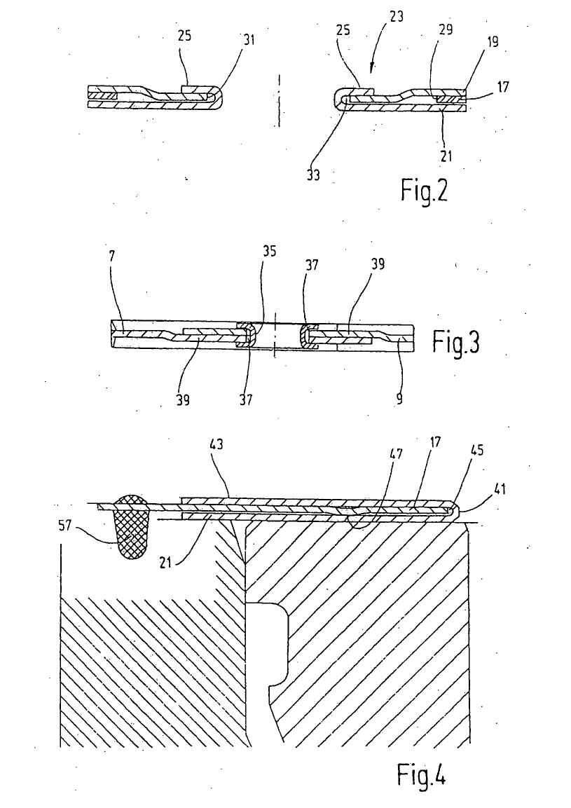

FIG. 2 shows a partial section drawn greatly enlarged compared to FIGS. 1A and 1B according to cutting line II-II from FIG. 1A;

FIG. 3 shows a partial section on the same scale as FIG. 2 according to cutting line III-III from FIG. 1A;

FIG. 4 shows a partial section on the same scale as FIGS. 2 and 3 according to cutting line IV-IV from FIG. 1B;

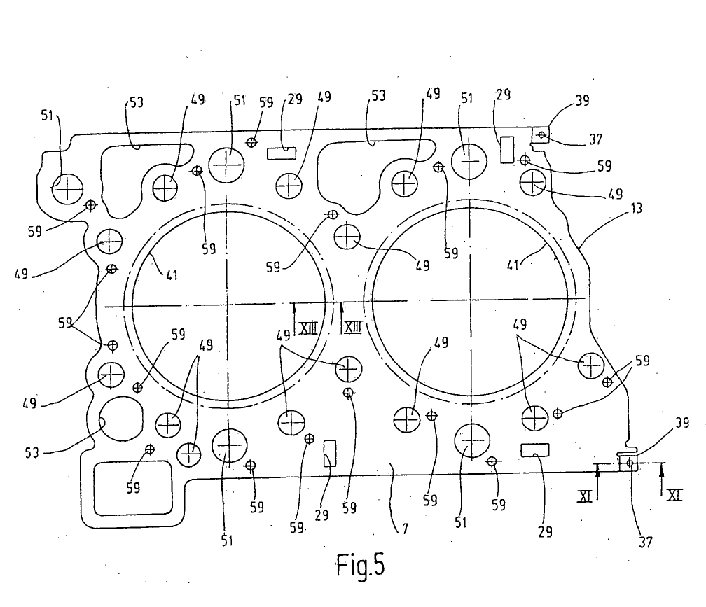

FIG. 5 shows an elevational view of a component element of the carrier element of the exemplary embodiment of the flat gasket, which component element is associated with cylinders one and two;

FIG. 6 shows in an elevational view corresponding to FIG. 5 the middle component element of the carrier element of the exemplary embodiment associated with cylinders three and four;

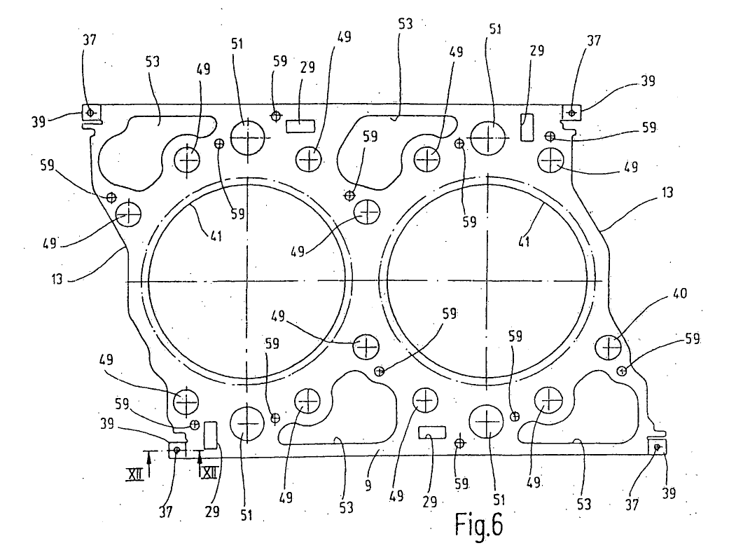

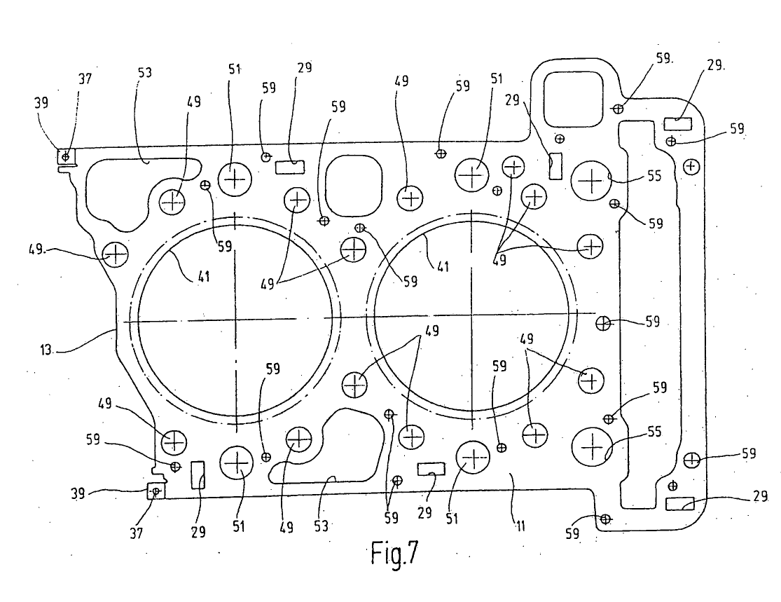

FIG. 7 shows in an elevational view corresponding to FIGS. 5 and 6 the component element of the carrier element of the exemplary embodiment associated with cylinders five and six;

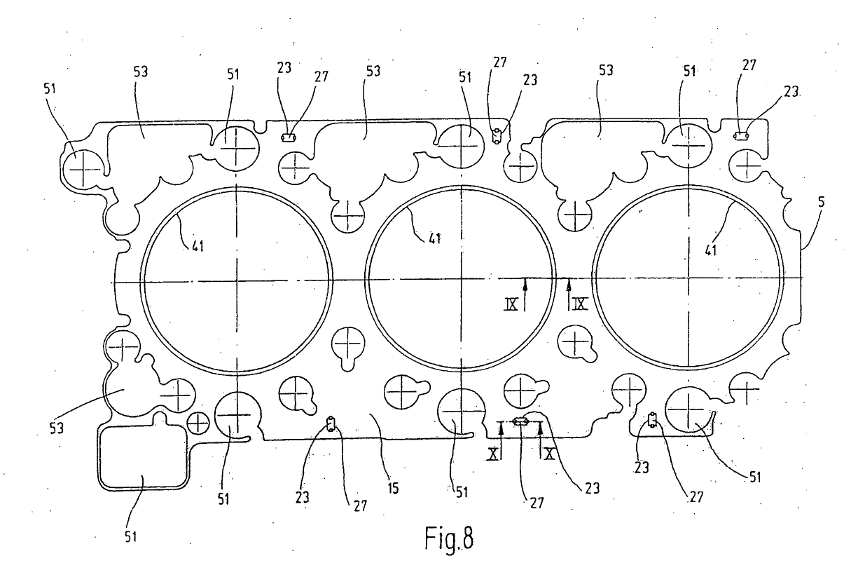

FIG. 8 shows an elevational view of the component element of the lower support element of the exemplary embodiment associated with cylinders one through three;

FIG. 9 shows a partial section drawn on the same scale as FIGS. 2 to 4 according to line IX-IX from FIG. 8;

FIG. 10 shows a partial section drawn on the same scale as FIG. 9 according to cutting line X-X from FIG. 8;

FIG. 11 shows a partial section drawn on the same scale as FIGS. 9 and 10 according to line XI-XI from FIG. 8;

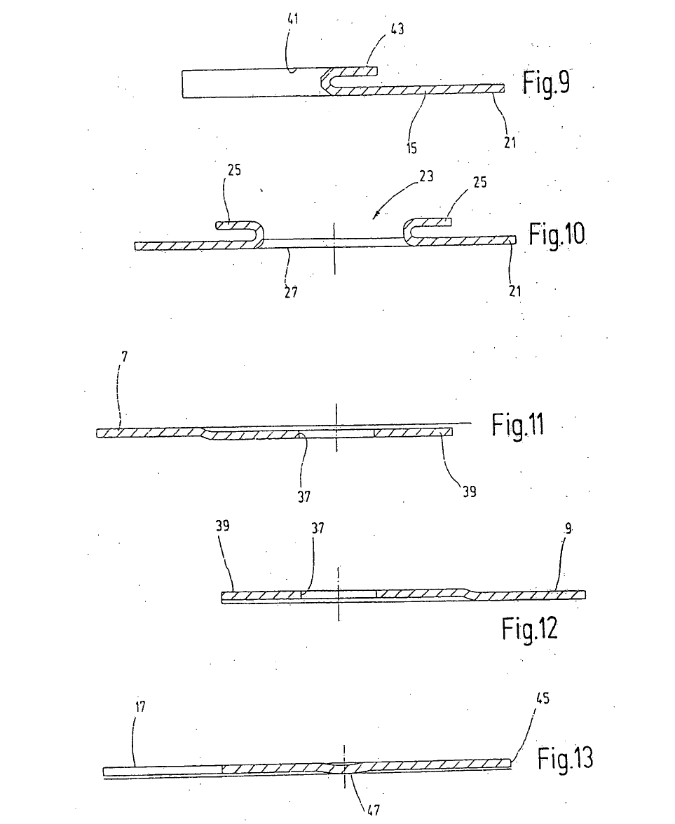

FIG. 12 shows a partial section drawn on the same scale as FIGS. 9 to 11 according to line XII-XII from FIG. 6 and

FIG. 13 shows a partial section drawn on the same scale as FIGS. 9 to 12 according to line XIII-XIII from FIG. 6.

The invention is explained below using one example of a cylinder head gasket for six cylinder, in-line engine. FIGS. 1A and 1B show in an elevational view the exemplary embodiment completed for use (delivery state), FIG. 1A showing the area of cylinders one to three and FIG. 1B showing the area of cylinders four to six. This embodiment is a combination of three metallic gasket layers, in the elevational view from FIGS. 1A and 1B the uppermost layer being shown in its entirety, specifically a first component element 1 and a second component element 3 of the upper support element 19 (FIG. 2) being shown, which is characterized in that the first component element 1 and the second component element 3 are interconnected on their straight connecting edges, each identified as 5, flush abutting one another.

Underneath the support element 19 formed from the component elements 1 and 3 is the carrier element 17 which is composed of three interconnected component elements 7 (FIG. 5), 9 (FIG. 6) and 11 (FIG. 7), which are likewise connected to one another, these component elements 7, 9 and 11 being interconnected abutting one another on the connecting edges 13. The carrier element 17 forms the middle layer under which in turn there is a lower support element 21 (FIG. 2) which like the upper support element shown in FIGS. 1A and 1B is composed likewise of two component elements, with an outline which corresponds to component elements 1 and 3, and of which only the component element 15 associated with cylinders one to three is shown in FIG. 8. As is to be seen from FIGS. 1A and 1B, the joining site of the component elements of the upper and lower support element, specifically the connecting edge 5, is axially offset relative to the joining site of the component elements 7, 9, 11 of the carrier element 17, as is apparent from FIGS. 1A and 1B in which the connecting edges 13 of the component elements 7, 9, and 11 of the carrier element 17 are shown by the dot-dash line.

The triple-layer structure of the cylinder head gasket consisting of the carrier element 17 which is composed of component elements 7, 9, 11, the upper support element 19 which is composed of component elements 1 and 3, and of the lower support element 21 which is composed of component elements 15, is best illustrated in FIG. 2. This figures shows highly enlarged, (approximately five times the size of the actual practical embodiment) the configuration of a connecting means in the form of cramping which acts between the lower support element 21, carrier element 17 and upper support element 19. As shown by FIGS. 1A and 1B, the locations of this cramping, identified as 23 in the figures, are distributed over the entire surface of the gasket. Each of these crampings 23 is formed by retaining projections 25 molded on the lower support element 21, as is detailed using FIG. 10, which shows a partial view according to line X-X from FIG. 8.

It is apparent therefrom that the retaining projections 25 on the notch 27 in the lower support element 21, i.e., according to FIG. 8 in the component element 15, are bent up and folded in directions opposite one another. In this connection the retaining projections 25 extend through recesses 29 which are formed in the component elements 7, 9 and 11 of the carrier element 17 up to the top of the upper support element 19 which the retaining projections 25 overlap, where they adjoin, forming the clamping engagement. As FIG. 2 clearly shows, the size of the recesses 29 in the carrier element 17 are chosen to be large enough so that the upper support element 19 can make contact with the lower support element 21 by means of bending down over the edge of the recess 29, where the lower support element 21 is held by the clamping engagement of the retaining projections 25, the carrier element 17 being cramped at the same time as the middle layer. As is likewise apparent from FIG. 2, the opening 31 provided in the upper support element 19 for passage of the retaining projections 25 is dimensioned such that between its opening edge and the enclosure a small free space 33 is formed by the retaining projections 25. As a result of this free space 33 and the free space formed on the edge of the recesses 29 of the carrier element 17, on each of the crampings 23 narrowly limited relative motion of the cramped layers to one another is possible.

As is apparent from the figures, the crampings 23 are turned by 90° to one another in alternation, as is also especially apparent from FIGS. 5 to 7, where the direction of the longitudinal axis of the recesses 29 which are made as oblong holes is clearly visible. Therefore limited relative motions in directions perpendicular to one another are possible on the crampings 23.

As already mentioned, the connecting means between the component elements 7, 9 and 11 of the carrier element 17 is a riveted connection with details shown in FIG. 3, which is an enlarged partial section according to cutting line III-III from FIG. 1A. This FIG. 3 shows, for example for the other riveted connections, only the riveted connection between the component elements 7 and 9 of the carrier element 17. As shown by FIGS. 11 and 12 which are partial sections according to lines XI-XI from FIG. 5 and XII-XII from FIG. 6, there are through holes 37 in the component elements 7 and 9 to be connected for passage of an associated hollow rivet 35. They are made in mounting tabs 39 which extend on the two side edges of the component elements 7 and 9, projecting in the longitudinal direction, see FIGS. 5 to 7. These mounting tabs 39 are, as illustrated in FIGS. 11 and 12, slightly bent in opposite directions out of the plane of the respective component elements 7 and 9. FIG. 3 shows the riveted state in which the mounting tabs 39 which adjoin one another with their bent-down area are overlapped by the edges of the hollow rivet 35. Moreover, FIG. 3 shows that the diameter of the through holes 37 in the component elements 7 and 9 is somewhat greater than the outer shaft diameter of the hollow rivet 35, so that in turn a small free space is formed which enables narrowly limited relative motion between riveted component elements, in FIG. 3 component elements 7 and 9.

FIGS. 4, 9, and 13 show details of the construction on the combustion chamber openings 41. Based on the partial section according to cutting line IX-IX from FIG. 8, FIG. 9 shows that the lower support element 21 (its component element 15 is shown in FIGS. 8 and 9) has a folded edge part 43. The latter, as shown by the section in FIG. 4 according to cutting line IV-IV from FIG. 1B, forms an edge enclosure for the opening edge 45 on the carrier element 17, a bead 47 which is arched out in the carrier element 17 as an arc of a circle in the direction to the lower support element 21 being enclosed at the same time. As is likewise apparent from FIG. 4, between the opening edge 45 and the enclosure by the folded edge part 43 there is in turn a small free space for enabling narrowly limited relative motion between the carrier element and enclosure.

In the manner conventional for these cylinder head gaskets, there is a comparatively large number of passages (which are not all identified and numbered in the drawings) in the carrier element 17 and in the support elements 19 and 21 outside of the combustion chamber openings 41 and outside of the notches 27 and recesses 29 provided for the cramping 23, specifically bolt holes 49 for cylinder head bolts, passages 51 for cooling water channels, passages 53 for oil return, passages 55 for pressurized oil. Other passages which are not shown are used among other things for crankcase ventilation, and form an access to the gear casings of the valve control and the like. These holes, channels and other unidentified and unnumbered passages are enclosed by sealing lips conventional for these gaskets, in the same manner as the outside edges of the gasket; these lips consist of an elastomer gasket material, in this example, rubber. The shape of the sealing zones which by these sealing lips which are identified as 57 (in FIGS. 1A and 1B only in summary at each single point and in FIG. 4), is apparent from the elevational view of FIGS. 1A and 1B. As is apparent, the sealing lips 57 also extend along the entire outside edge of the gasket with the exception of the riveted areas with the hollow rivets 35, and as an enclosure around the passages which are provided for the cooling and lubricating fluids and the like. The sealing lips of the middle or carrier layer which are located in the direction of the engine block are made longer in axial height than the overlying sealing lips which are oriented in the direction of the upper cover layer of the multilayer cylinder head gasket and for this purpose project in the direction of the cylinder head before installation.

Since the flat gasket as claimed in the invention both with regard to the carrier element 17 and also with regard to the support elements 19, 21 is composed of several component elements, which each have only a fraction of the entire length, it is possible to inject the sealing lips 57 directly onto the component elements 7, 9, and 11 of the carrier element 17. In the drawings the injection sites which are provided on the carrier element 17 to form the different sealing zones formed by the sealing lips 57 are identified only in FIGS. 1A and 5 to 7 and designated as 59. The sealing lips 57 form bead-like sealing strips which project slightly out of the main plane of the gasket, as is conventional in these gaskets.

As FIGS. 1A and 1B clearly show, the component elements 1 and 3 of the upper support element 19, as is also the case for the lower support element 21, are interconnected on each straight connecting edge 5, that is to say, with a straight joining site. As is especially clear from FIG. 6, conversely for the carrier element 17 the joining sites between the component elements 7, 9 and 11 are formed by a connecting edge 13 which runs corrugated and obliquely to the longitudinal direction. The course of these connecting edges 13 is selected such that the joining site does not touch any of the holes or passages in the component elements 7, 9 and 11. As is likewise apparent from FIG. 6, the component element 9 shown in this figure has a symmetrical shape, more specifically there is symmetry with respect to the obliquely running axes of symmetry which extend beyond the combustion chamber openings 41 between the bolt holes 37 for the hollow rivet.

It goes without saying that especially in the case of very elongated engine blocks, there can be several identically made component elements, for example several with a symmetrical configuration, such as is the case in the example from FIG. 6. As a result of the corresponding symmetry, those component elements in their main plane turned by 180° can each be connected to one another; this can simplify the installation process.

1. Flat gasket, especially a cylinder head gasket, having at least one elongated, metallic carrier element (17) which extends over several sealing zones, preferably over several combustion chamber sealing zones (41) for several in-line cylinders of a piston engine, characterized in that the carrier element (17) is formed by several component elements (7, 9, 11) which are interconnected by a connecting means (35, 37), abutting one another.

2. The flat gasket as claimed in claim 1, wherein there is at least one support element (19, 21) extending essentially over the length of the carrier element (7), adjoining the latter, and it is likewise formed from several interconnected component elements (1, 3, 15).

3. The flat gasket as claimed in claim 2, wherein the number of component elements (7, 9, 11) of the carrier element (17) is different from the number of component elements (1, 3, 15) of at least one of the support elements (19, 21) from one another, and wherein the joining sites of the component elements (7, 9, 11; 1, 13, 15) of the carrier element (17) and at least one of the support elements (19, 21) are spaced axially apart from one another in the longitudinal direction of the flat gasket.

4. The flat gasket as claimed in claim 3, wherein the number of component elements (7, 9, 11) of the carrier element (17) is greater by at least one than the number of component elements (1, 3, 15) of at least one of the support elements (19, 21).

5. The flat gasket as claimed in claim 3, wherein to implement the triple-layer gasket structure the carrier element (17) is held at least partially between two support elements (19, 21) which are made as upper and lower cover layers.

6. The flat gasket as claimed in claim 2, wherein on both sides of the carrier element (17) there is one support element (19 and 21) each and wherein there is a second connecting means (23) which is active both between component elements (1, 3, 15) of the two support elements (19, 21) and also component elements (7, 9, 11) of the carrier element (17).

7. The flat gasket as claimed in claim 1, wherein the first connecting means active between the component elements (7, 9, 11) of the carrier element (17) is a riveted connection (35, 37).

8. The flat gasket as claimed in claim 7, wherein the second connecting means is formed by cramping (23).

9. The flat gasket as claimed in claim 8, wherein the cramping (23) has retaining projections (25) which are molded in one piece on the component elements (15) of one of the support elements (21) as projecting parts and can be deformed for cramping engagement with the pertinent component elements of the other support element (19).

10. The flat gasket as claimed in claim 9, wherein the retaining projections (25) extend from the component element (15) of the lower support element (21) through recesses (29) in the carrier element (17) and through openings (31) in the upper support element (19) and are folded for clamping engagement adjoining its top and wherein the recesses (29) in the carrier element (17) are dimensioned large enough so that the area of the upper support element overlapped by the retaining projections (25) in the free space formed by the respective recess (29) of the carrier element (17) can be placed against the top of the lower support element (21).

11. The flat gasket as claimed in claim 7, wherein the riveted connection acting between the component elements (7, 9, 11) of the carrier element (17) is formed by hollow rivets (35).

12. The flat gasket as claimed in claim 11, wherein to form the riveted connection, tabs (39) which project in the longitudinal direction of the carrier element (17) are molded onto the two side edges of the abutting component elements (7, 9, 11) of the carrier element (17) and are staggered in areas by an offset out of the main plane of the carrier element (17), and are adjoined by an associated tab (39) of the bordering component element (7, 9, 11), which tab is offset in the opposite direction, and wherein the tabs (39) are each provided with a through hole (37) for a hollow rivet (35).

13. The flat gasket as claimed in claim 12, wherein the through holes (37) have a slightly larger diameter than the shaft of the hollow rivet (35) which extends through it.

14. The flat gasket as claimed in claim 1, wherein elastomer sealing lips (57), which are molded directly (at 59) on the carrier element (17), form sealing zones on the edge areas of the flat gasket and on openings which are formed therein for example for passage of bolts or as channels for cooling and lubricating fluids or the like.
